(19) United States
(12) Patent Application Publication
(10) Pub. No.: US 2010/0131221 A1
(43) Pub. Date: May 27, 2010

(54) METHOD FOR DETERMINING QUALITY PARAMETER AND THE ELECTRONIC APPARATUS USING THE SAME

(76) Inventor: Chih-Sheng Chien, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/626,673

(22) Filed: Nov. 26, 2009

(30) Foreign Application Priority Data
Nov. 27, 2008 (TW) 097145899

(51) Int. Cl. G06F 19/00

(52) U.S. Cl. 702/81

(57) ABSTRACT

The invention provides a method for determining quality parameter and the electronic apparatus using the same. The electronic apparatus includes a central processing unit (CPU) and a memory module. The method includes the following steps: performing a CPU overclocking process to obtain a highest operable CPU frequency; tuning a quality parameter and performing a memory test to obtain a test result; and determining an optimal value based on the test result to be a default value of the quality parameter.

### BACKGROUND OF THE INVENTION

1. Field of the Invention

The invention relates to a method for setting computers and an electronic apparatus using the same.

2. Description of the Related Art

With the improvement of computer technology, users might have demands to further fine tune a central processing unit (CPU) or a memory module of a computer system. With using overclocking technique, performance of a computer system can be improved to make the CPU or the memory module thereof operates at a higher frequency. For this purpose, values related to the control signals of the memory module are provided in the basic input/output system (BIOS) which stores all hardware information of the computer. Said BIOS comprises memory module control signals related values, may be called quality parameter, includes address/command (Addr/Cmd) signal fine delay, chip select/on-die termination (CS/ODT) signal fine delay, data strobe (DQS) signal fine delay, and clock enable (CKE) signal fine delay. As a result, overclocking players or hardware engineers can make some fine tunings to the values manually to improve the overclocking performance of the memory.

However, in conventional architecture, changes of the quality parameter are stored after reboot, and these changes can only be tested after entering operating system (such as DOS) to check if the changes lead to a crash. With such, users must to repeatedly tune the quality parameter in the BIOS, reboot the computer and enter the disk operating system (DOS), then execute a test program to determine if there is enough signal margin to be overclocking spaces. If the system or the CPU or the memory module cannot operate with the set quality parameter after the fine tuning, the performance of the system will be reduced, and even crash directly or cause a data damage.

Thus, a method for determining quality parameter, particularly determining quality parameter relative to signal margins for control signals of a memory module, to immediately obtaining a test result is needed to facilitate overclocking.

### BRIEF SUMMARY OF THE INVENTION

The invention provides a method for determining quality parameter and the electronic apparatus using the same to facilitate overclocking. The invention can used to easily obtain related signal margins for related control signals of memory modules to facilitate overclocking.

To achieve the objective, the invention provides a method for determining quality parameter of a memory module in an electronic apparatus having a CPU comprising: executing a CPU overclocking process to obtain a highest operable CPU frequency; tuning the frequency of the CPU to the highest operable CPU frequency and tuning the frequency of the memory module; tuning a quality parameter of the memory module and performing a memory test to obtain a test result; determining an optimal value based on the test result; and setting the optimal value as a default value of the quality parameter of the memory module.

Also, the method may exclude the steps of executing a CPU overclocking process to obtain a highest operable CPU frequency and tuning the frequency of the CPU to the highest operable CPU frequency and tuning the frequency of the memory module. Therefore, the present application also provides a method for determining quality parameter of a memory module in an electronic apparatus comprising: tuning a quality parameter of the memory module and performing a memory test to obtain an upper bound and a lower bound of the quality parameter; and determining an optimal value to be the default value of the quality parameter based on the upper bound and the lower bound of the quality parameter; wherein the quality parameter includes an address/command signal fine delay, a CS/ODT signal fine delay, a DQS signal fine delay, and a CKE signal fine delay.

It is noted that the memory test is performed by a memory test program built in firmware, e.g. the BIOS.

Likely, an upper bound and a lower bound of the quality parameter may be the test result obtained by the step of tuning a quality parameter of the memory module and performing a memory test, whereby to obtain the optimal value.

The invention further provides an electronic apparatus comprising a CPU, a memory module, an overclocking unit, a tuning unit, a processing unit and a determining unit. The memory module has a quality parameter. The overclocking unit executes a CPU overclocking process to obtain a highest operable CPU frequency. The tuning unit tunes the quality parameter. The processing unit performs a memory test to obtain a test result. The determining unit determines an optimal value of the quality parameter based on the test result.

Notely, the quality parameter includes address/command signal fine delay, CS/ODT signal fine delay, DQS signal fine delay, and CKE signal fine delay.

These and other features, aspects and advantages of the present invention will become better understood with regard to the following description, appended claims, and accompanying drawings.

### BRIEF DESCRIPTION OF THE DRAWINGS

FIG. 1 is a block schematic diagram showing an electronic apparatus according to an embodiment of the invention;

FIG. 2 is a flow chart showing a method for determining quality parameter of control signals of a memory module according to an embodiment of the invention;

FIG. 3 is a flow chart showing a method for determining quality parameter of control signals of a memory module according to another embodiment of the invention;

FIG. 4 is a comparison table showing quality parameter and related settings according to an embodiment of the invention;

FIG. 5 is a detailed flow chart showing a method for determining quality parameter according to an embodiment of the invention; and

FIG. 6 is a schematic diagram showing a process of choosing test pattern according to an embodiment of the invention.

### DETAILED DESCRIPTION OF THE EMBODIMENTS

The embodiment of the invention provides a method for determining quality parameter of memory module control signals.

Conventionally, memory module control signals may include Addr/Cmd signal, CS/ODT signal, DQS signal and CKE signal, and quality parameter of the memory module may include Addr/Cmd signal fine delay, CS/ODT signal fine delay, DQS signal fine delay, CKE signal fine delay and so on.

The method for determining quality parameter can be used for providing overclocking players or hardware engineers an auxiliary memory test program built in firmware, e.g. the BIOS, and make it easier to know how to make the fine tune to improve the stability and the overclocking performance of the system without tedious reboot procedure or worrying about losing or damaging data in the system. In the method, a memory test is performed automatically or manually to provide the results after every fine tuning. Then, signal margins for quality parameter of control signals that allows the memory module normally operate are found out, and an optimal value is obtained from the signal margin to provide the best overclocking performance for users. It is noted, the fine tunings of quality parameter is performed without changing the original configuration of the memory modules.

It is noted that the memory test is performed by a memory test program that built in a firmware, e.g. the BIOS.

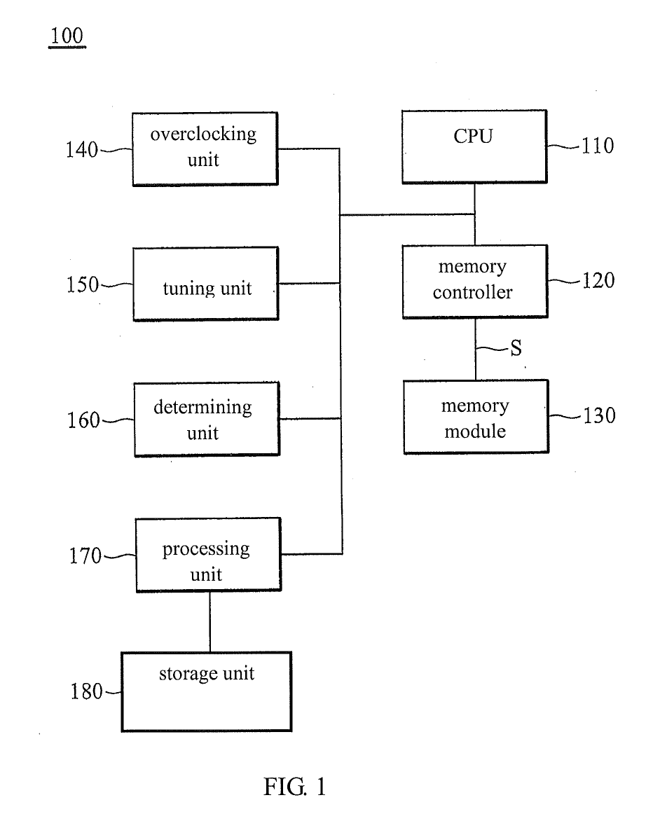

FIG. 1 is a block schematic diagram showing an electronic apparatus 100 according to an embodiment of the invention. In FIG. 1, an electronic apparatus 100 includes a CPU 110, a memory controller 120, a memory module 130, an overclocking unit 140, a tuning unit 150, a determining unit 160, and a processing unit 170. The CPU 110 is coupled to the memory controller 120, the overclocking unit 140, the tuning unit 150, the determining unit 160 and the processing unit 170 via a bus.

The memory controller 120 controls the configuration of the memory module 130 via control signals S and accesses the memory module 130. The control signals S includes Addr/Cmd signal, CS/ODT signal, DQS signal and CKE control signal. The Addr/Cmd signal is used for assigning a memory unit for accessing data in the memory module 130. The CS signal is used for enabling the memory module 130. The CKE control signal is used for enabling a clock signal of the memory module 130. The ODT signal is used for enabling on-die termination resistors which are used for receiving data signals. The quality parameter includes, but is not limited to, predetermined time and delay time. For example, the tuning of quality parameter includes fine tuning an Add/Cmd signal fine delay, a CS/ODT signal fine delay, a DQS signal fine delay, and a CKE signal fine delay. The fine tuning of the CS/ODT signal fine delay is used for controlling the delay time between CS/ODT pins and a predetermined time. The CKE predetermined time setting is used for setting the predetermined time for the CKE pin. The fine tuning of the CKE signal fine delay is used for controlling the delay time between the CKE pin and the predetermined time.

The performance of the memory module 130 can be changed via different values. However, signal margins for the quality parameter of the memory module 130 must be found to ensure that the memory module 130 normally operates. If the value of quality parameter of the memory module 130 exceeds the range of the signal margin, the performance of the memory module 130 may be reduced or even damaged.

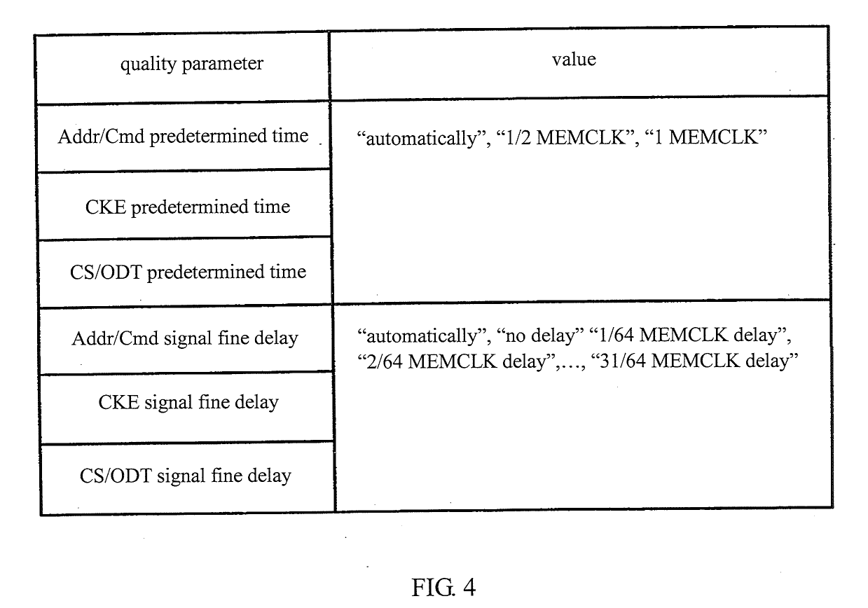

Please refer to FIG. 4. FIG. 4 is a comparison table 400 that shows quality parameter and value according to an embodiment of the invention. For example, the predetermined time of the CS/ODT includes “automatically”, “½ MEMCLK”, and “1 MEMCLK” are options provided for users to choose, such as “automatically”, “no delay” “ 1/64 MEMCLK delay”, “ 2/64 MEMCLK delay”, “ 31/64 MEMCLK delay” are the value to tune. MEMCLK represents the clock cycle of the memory module of the system. For example, when the CS/ODT delay time is set to be “ 2/64 MEMCLK delay”, it means that the CS/ODT delay time is a 2/64 clock cycle of the memory module of the system after the CS/ODT default time.

When the fine tuning function for the quality parameter of the memory module is enabled, the overclocking unit 140 executes a CPU overclocking process and tunes the system frequency (the operating frequency of the CPU 110) to obtain the highest operable CPU frequency which allows the system to be working normally. The tuning unit 150 is used for tuning the value of quality parameter. The processing unit 170 performs a memory test after tuning the quality parameter to obtain a test result, for example, an upper bound and a lower bound of the quality parameter. The determining unit 160 determines an optimal value of the quality parameter based on the test result such as the upper bound and the lower bound of the quality parameter obtained by the tuning unit 150. Detailed data processing flow will be introduced as follows.

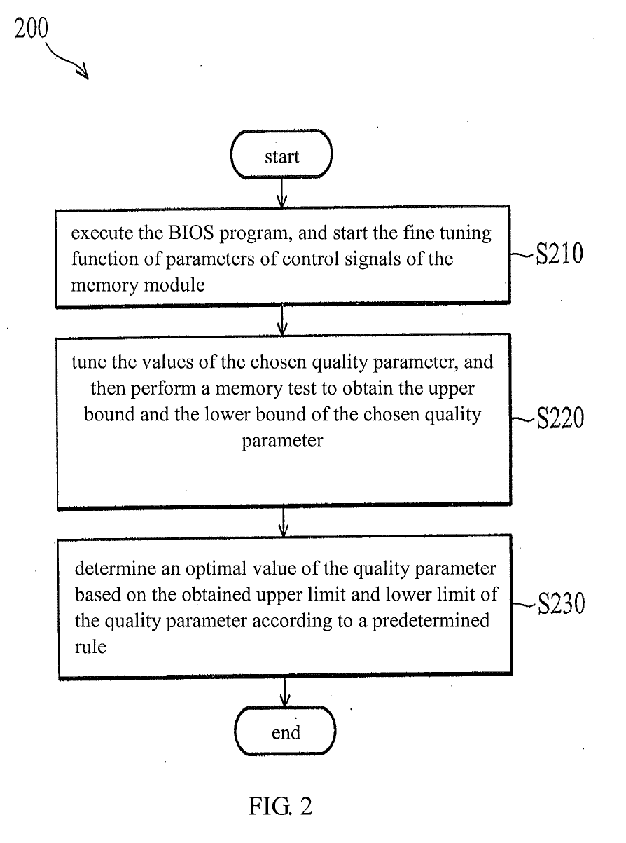

FIG. 2 is a flow chart showing a method 200 for determining quality parameter according to an embodiment of the invention. Please also refer to FIG. 1. Firstly, when a user wants to fine tune quality parameter of control signals of the memory module, at step S210, the user starts the fine tuning function for quality parameter of control signals of the memory module when executing the BIOS program. After the fine tuning function for quality parameter of control signals of the memory module is enabled, the apparatus 100 provides a menu including options list (not shown) of all tunable quality parameter. Users can choose a quality parameter from the menu to fine tune. The quality parameter includes a default value for the memory module to initially operate stably and normally. Generally speaking, the quality parameter includes a signal margin at each frequency. The signal margin varies with the types or arrangements of the memory modules.

Next, at step S220, the tuning unit 150 automatically tunes the value of the chosen quality parameter. Then, the processing unit 170 performs a memory test to the system, and preferably performs a read/write test to the memory module 130 to test the stability of the system after the tuning. Thus, the upper bound and the lower bound of the chosen quality parameter are obtained. The upper bound and the lower bound can define the signal margin for the chosen quality parameter. In other words, the memory module 130 can operate at any value between the upper bound and the lower bound normally and stably.

Afterward, at step S230, the determining unit 160 determines an optimal value of the quality parameter based on the obtained upper bound and lower bound of the quality parameter according to a predetermined rule. The predetermined rule may be an operation mode. For example, the optimal value may be, but not limited to, an average value of the upper bound and the lower bound.

Then, users can set the determined optimal value as the default value of the chosen quality parameter, and the CPU 110 controls the output of the control signals of the memory controller 120 according to the new defualt value (optimal value) to access the memory module 130. Since the optimal value is confirmed in advance of starting the system, the system can keep stably operating at the effective operating frequency of the CPU 110, the electronic apparatus 100 can obtain the best overclocking performance.

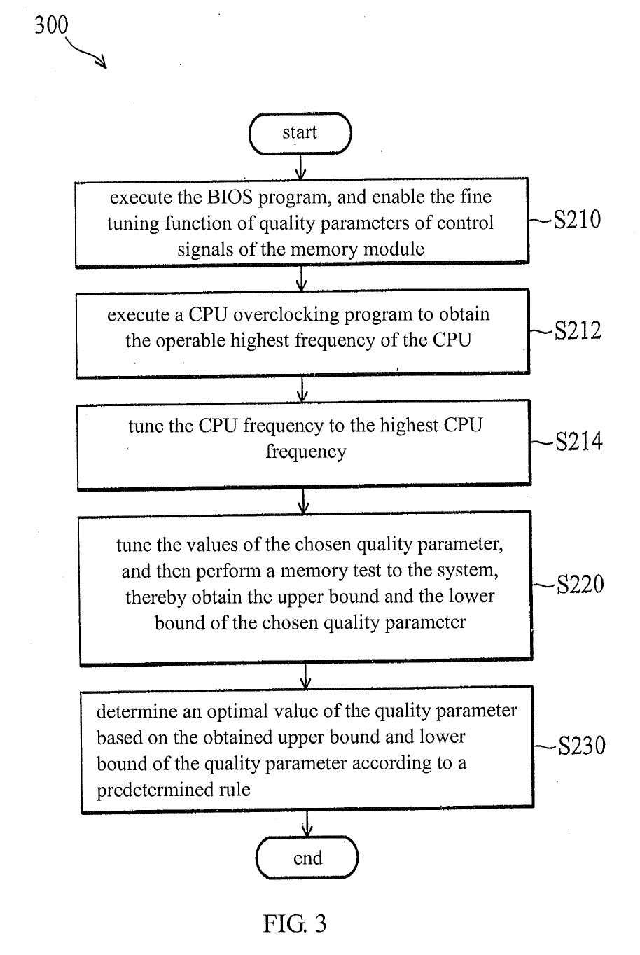

To obtain the upper bound and the lower bound of the signal margin more quickly, according to another embodiment of the invention, the overclocking unit 140 can execute a CPU overclocking process before step S220. Please refer to FIG. 3.

FIG. 3 is a flow chart showing a method 300 for determining quality parameter according to another embodiment of the invention.

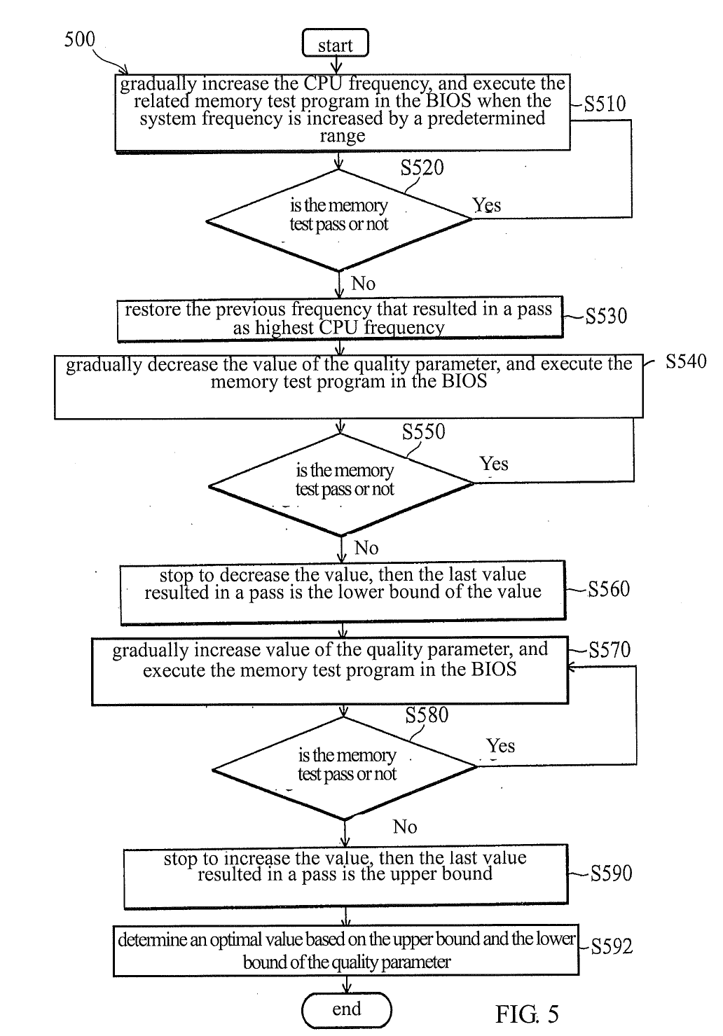

The method 300 is similar to the method 200. The difference is that a step S212 of executing a CPU overclocking process is performed after step S210 to obtain the highest operable CPU frequency. The CPU overclocking process, used for tuning the CPU frequency, can gradually increase the present CPU frequency and perform a test to find the highest operable CPU frequency. Next, at step S214, the frequency of the CPU is tuned to the highest operable CPU frequency. A detailed method for obtaining the highest operable CPU frequency by the CPU overclocking process is shown in the following description of FIG. 5.

When the CPU frequency is tuned to the highest frequency, the operating frequency of the memory module is tuned from the original frequency to a new operating frequency which is higher than the original frequency and corresponds to the highest frequency.

Next, the memory module is operated at the new operating frequency, and steps S220 and 5230 are performed. At step S220, the value of the chosen quality parameter is automatically tuned, and then a memory test is performed to the system of which the quality parameter is tuned to test the stability of the system. Thus, an upper bound and a lower bound of the chosen quality parameter are obtained. At step S230, the optimal value of the quality parameter is determined based on the upper bound and the lower bound of the quality parameter.

Conventionally, since the frequency of the memory module is increased accordingly when the CPU frequency is increased, the memory module can be overclocked when CPU overclocking process is performed. The memory module has different signal margins at different frequencies, and the signal margin is smaller as the operating frequency is higher. Therefore, it takes less time for determining the upper bound and the lower bound based on the method provided herein.

For example, the signal margin for a quality parameter is 10-90 when the memory module operates at the first frequency (such as 500 MHz), and the signal margin may be reduced to 30-70 when the memory module operates at a second frequency (such as 600 MHz) which is higher than the first frequency. In other words, the signal margin can be found more quickly when the frequency of the memory module is increased.

FIG. 5 is a detailed flow chart showing a method 500 for determining quality parameter according to an embodiment of the invention. In this embodiment, the electronic apparatus 100 at least has a function for adjusting value of the quality parameter. If users want to fine tune the value, they may enter the BIOS setting window, choose the quality parameter (such as the CS/ODT signal fine delay in FIG. 4) which they want to fine tune and press the predetermined hot key to launch the automatic fine tuning function.

Next, a CPU overclocking process at steps S510-S530 is performed to obtain a highest operable frequency of the CPU. The method is mainly described hereinafter.

At step S510, the CUP frequency is increased, and the memory test program built in the BIOS is executed after the CUP frequency is increased by a certain frequency. Next, at step S520, the test result of the memory test is determined. If the test result of the memory test is pass (“Yes” at step S520), steps S510-S520 are performed repeatedly. Such as to increase the CPU frequency, perform memory test and determine the test result of memory test. Conversely, if the test result of the memory test is fail (“No” at step S520), at step S530, the previous frequency that resulted in a pass is restored as the highest operable frequency of the CPU.

Detaily, to obtain the highest operable frequency of the CPU, an original operable CPU frequency is increased by a predetermined range (such as a predetermined frequency) to obtain a first test value, then the memory test is performed. If the test result of the memory test is pass, the first test value is increased by a predetermined range to obtain a second test value and repeat the memory test. If the test result of the second test value is pass, the second test value is increased by a predetermined range to obtain a third test value and the memory test is performed again. As stated above, the test result of the memory test is determined, the test value is increased by a predetermined range, and the memory test is repeatedly performed until the test result of the memory test is fail. Once the test result is fail, the previous frequency that resulted in a pass is set as the highest operable CPU frequency (for example, the second test value is set as the highest operable CPU frequency when the test result of the memory test for the third test value is fail).

On the other hand, the original CPU frequency which would be set as the highest operable CPU frequency if the test result of the memory test performed first time is fail.

After the CPU overclocking process is finished, at the following steps S540-S590 is to obtain the upper bound and the lower bound of the value of the quality parameter. The method is described as follows.

To facilitate distinguishing memory tests in different steps of whole process, the memory tests after steps S510-S530 may be identified as initial memory test and additive memory test. The initial memory means the memory test performed for an original operable quality parameter, and the additive memory test means the memory test performed for following again-increased quality parameter. However, it is noted that the initial memory test and the additive memory test are the same performed by the memory test program built in the BIOS.

At step S540, the value of the quality parameter to be fine tuned is gradually decreased from the default value, and the memory test program of the BIOS is automatically executed when the value is decreased to a certain extent. Next, at step S550, it is determined that whether the test result of the memory test is pass or not. If the test result of the memory test is pass (“Yes” in step S550), steps S540-S550 are performed repeatedly. The value of the quality parameter is automatically decreased, and then the memory test program built in the BIOS is executed and the test result of the memory test is determined. If the test result of the memory test is fail (“No” at step S550), at step S560, stop to decrease the value, then the last value resulted in a pass is the lower bound of the value.

Next, at step S570, the value of the quality parameter to be fine tuned is gradually increased from the default value, and the memory test program that built in the BIOS is automatically executed when the frequency is increased to a predetermined value. Next, at step S580, it is determined that whether the test result of the memory test is pass or not. If the test result of the memory test is pass (“Yes” in step S580), steps S570-S580 are performed repeatedly. The value is automatically increased, and the memory test program built in the BIOS is executed then the test result is determined. If the test result of the memory test is fail (“No” in step S580), at step S590, stop to increase the value, then the last value resulted in a pass is the upper bound.

Therefore, to obtain the upper bound of the quality parameter, the default value of the quality parameter is increased by a predetermined range to obtain a first test value, and then the initial memory test is performed for the first test value. It is determined that whether an additive memory test needs to be performed or not based on the test result of the initial memory test. If the test result of the initial memory test is pass, the first test value is increased by the predetermined range to obtain a second test value, and the additive memory test is performed for the second test value. If the test result of the additive memory test to the second test value is pass, the second test value is increased by the predetermined range to obtain a third test value, and the additive memory test is performed for the third test value. As stated above, the memory test is performed until the test result is fail. The last passed test value is set as the upper bound.

On the other hand, if the test result of the initial memory test is fail for the default value, the default value of the quality parameter is set as the upper bound.

Further, to obtain the lower bound of the quality parameter, the default value of the quality parameter is gradually decreased by a predetermined range to obtain a first test value, and then the initial memory test is performed for the first test value. It is determined that whether an additive memory test needs to be performed or not based on the test result of the initial memory test.

If the test result of the initial memory test is pass, the first test value is decreased by the predetermined range to obtain a second test value, and the additive memory test is performed for the second test value. If the test result of the additive memory test for the second test value is pass, the second test value is decreased by the predetermined range to obtain a third test value, and the additive memory test is executed for the third test value. As stated above, the value is gradually decreased, and the additive memory test is performed repeated for different test values until the test result of the additive memory test is fail. The test value that passed the last memory test is set as the lower bound.

On the other hand, if the test result of the initial memory test is fail, the default value of the quality parameter is set as the lower bound.

The upper bound and the lower bound of the quality parameter are obtained according to the above tuning process. Next, at step S592, an optimal value is generated based on the upper bound and the lower bound of the quality parameter. For example, the optimal value of the largest signal margin may be an average value of the upper bound and the lower bound. Next, since users may set the optimal value according to the results of automatic fine tunings as the quality parameter, the best overclocking performance is obtained.

Moreover, another embodiment is further included test programs and multiple memory test pattern groups that respectively corresponding to different brands of memory modules. The test programs and memory test pattern groups may be stored in a storage unit 180. The processing unit 170 may perform a memory test to obtain a test result. Preferably, the processing unit 170 further chooses a test pattern group according to the type of the memory module and performs an appropriate test program based on the test pattern group.

Notely, a memory module normally comprises a plurality of cells, and each pattern group includes at least one test pattern that contains instructions for the memory test. According to the test pattern, the processing unit 170 may performs a memory test to obtain the test result. Said memory test may be read/write to different cells of the memory module to obtain the signal margin for the quality parameter of the memory module.

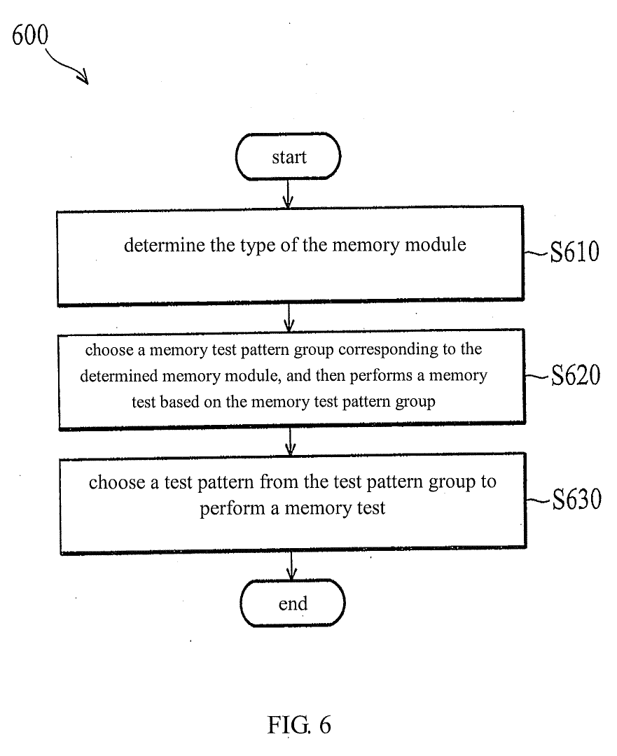

In FIG. 6, firstly, at step S610, the type of the memory module is determined. Afterward, at step S620, chooses a memory test pattern group corresponding to the determined memory module. Next, at step S630, a test pattern is chosen from the test pattern group to perform a memory test to obtain a test result. At step S630, additionally, the apparatus provides a menu listing all test patterns in the test pattern group for users to choose. For example, the test pattern group includes a first test pattern and a second test pattern. The first test pattern contains instruction to write/read a data “1” among all cells of the memory module to determine that whether the memory module normally operates or not. The second test pattern contains instruction to write/read a data “0” among all cells of the memory module to determine that whether the memory module normally operates or not. With the memory tests according to the first and the second test patterns, the stability of the memory module is confirmed.

Consequently, in the choosing process of the memory test pattern, users may choose different kinds of memory test patterns for memory test, thereby to obtain higher overclocking performance.

Furthermore, according to an embodiment of the invention, users can also tune the value of the quality parameter manually. After users tune the value, the configured setting is performed immediately when the value of the quality parameter is changed without reboot the computer. Accordingly, the users can press another hot key to execute a memory test program to known that whether the memory module can stably operate at the tuned parameter or not.

For example, users can input a manual tuning command and then input a value of the quality parameter. For example, in FIG. 4, users may assign the value of the quality parameter. Afterward, users press a hot key to execute a memory test program that built in the BIOS to test whether the memory module can stably operate at the inputted value or not. The test result of the memory test is responded to the users immediately. If the test result is abnormal, it represents that the value is not proper and users cannot overclock the computer with this value, thereby it assures that the memory module is not operated at an improper value, and users need not worry about data losing or damaging might occur.

Above all, according to the method for determining quality parameter and the electronic apparatus using the same of the invention, the electronic apparatus automatically performs a CPU overclocking process to set the CPU at the highest operable frequency, and then the quality parameter is tuned and a memory test is performed to obtain a test result. The optimal value of the quality parameter is obtained based on the test result. Since the test result of the fine tuning is observable when the quality parameter is tuned, the users do not have to reboot or worry about leading to a crash to lost or damage the data of the system.

The above description provides some embodiments or methods of using the invention. The apparatuses and the methods according to the embodiments are used for helping with explaining the spirit and the purpose of the invention, and the scope of the invention is not limited thereto.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for determining quality parameter for an electronic apparatus having a CPU and memory module comprising:
executing a CPU overclocking process to obtain a highest operable CPU frequency;
tuning the frequency of the CPU to the highest operable CPU frequency and tuning the frequency of the memory module;
tuning the quality parameter of the memory module and performing a memory test to obtain a test result;
determining an optimal value based on the test result; and
setting the optimal value as a default value of the quality parameter of the memory module.

2. The method according to claim 1, wherein the step of executing the CPU overclocking process to obtain the highest operable CPU frequency comprises:
increasing a CPU frequency and performing a memory test; and
determining whether the test result of the memory test is pass or not;
wherein if the test result of the memory test is pass, repeating the step of increasing the frequency of the CPU, performing the memory test and determining whether the test result of the memory test is pass or not; if the memory test is failed, stop to increase the frequency, then the last passed frequency is the highest operable CPU frequency.

3. The method according to claim 1, wherein the test result comprises an upper bound and a lower bound.

4. The method according to claim 3, wherein the step of determining an optimal value based on the test result comprises:
averaging the test result to obtain an average value as the optimal value.

5. The method according to claim 3, wherein the step of tuning the quality parameter of the memory module and performing a memory test to obtain a test result comprises:
decreasing a value of the quality parameter by a predetermined range and performing the memory test; and
determining whether the memory test is passed or not;
wherein if the test result of the memory test is pass, repeating the step of decreasing the value of the quality parameter, performing the memory test and determining whether the memory test is pass or not; if the memory test is failed, stop to decrease the value, then the last passed value is the lower bound.

6. The method according to claim 3, wherein the step of tuning the quality parameter of the memory module and performing a memory test to obtain a test result comprises:
increasing a value of the quality parameter by a predetermined range and performing the memory test; and
determining whether the memory test is passed or not;
wherein if the test result of the memory test is passed, repeating the step of increasing the value of the quality parameter by a predetermined range, performing the memory test and determining whether the memory test is passed or not; if the memory test is failed, stop to increase the value, then the last passed value is the upper bound.

7. The method according to claim 1, wherein the quality parameter includes address/command signal fine delay, CS/ODT signal fine delay, DQS signal fine delay and CKE signal fine delay.

8. The method according to claim 1, further comprises:
obtaining a memory test pattern group corresponding to a type of the memory module; and
performing a memory test base on the obtained memory test pattern group.

9. The method according to claim 1, wherein the step of performing a memory test base on the obtained memory test pattern group comprises:
choosing a first memory test pattern from the memory test pattern group; and
performing the memory test according to the first memory test pattern.

10. The method according to claim 8, wherein the step of performing a memory test base on the obtained memory test pattern group further comprises:
choosing a second memory test pattern from the memory test pattern group; and
performing a memory test according to the second memory test pattern.

11. The method according to claim 1, wherein the step of tuning the quality parameter of the memory module and performing a memory test to obtain a test result comprising:
inputting a tuning command manually;
inputting a tuning value of the quality parameter; and
performing the memory test to obtain a test result.

12. An electronic apparatus, comprising:
a CPU;
a memory module having a quality parameter;
an overclocking unit executing a CPU overclocking process to obtain a highest operable CPU frequency;
a tuning unit tuning the quality parameter;
a processing unit performing a memory test to obtain a test result; and
a determining unit determining an optimal value of the quality parameter based on the test result.

13. The electronic apparatus according to claim 12, further comprising:
a storage unit providing memory test patterns.

14. The electronic apparatus according to claim 13, the processing unit further for choosing a memory test pattern from the memory test patterns and performing the memory test according to the obtained memory test pattern.

15. The electronic apparatus according to claim 14, wherein the processing unit further chooses a first memory test pattern and a second memory test pattern from the memory test patterns for perform the memory test.

16. The electronic apparatus according to claim 12, wherein the quality parameter includes address/command signal fine delay, CS/ODT signal fine delay, DQS signal fine delay and CKE signal fine delay.

17. A method for determining quality parameter of a memory module in an electronic apparatus, the method comprising:
tuning a quality parameter of the memory module and performing a memory test to obtain an upper bound and a lower bound of the quality parameter; and
determining an optimal value to be the default value of the quality parameter based on the upper bound and the lower bound of the quality parameter,
wherein the quality parameter includes an address/command signal fine delay, a CS/ODT signal fine delay, a DQS signal fine delay, and a CKE signal fine delay.

18. The method according to claim 17, wherein the step of tuning a quality parameter of the memory module and performing a memory test to obtain an upper bound and a lower bound of the quality parameter comprises:
decreasing a value of the quality parameter by a predetermined range and performing the memory test; and
determining whether the memory test is passed or not;
wherein if the memory test is passed, repeating the step of decreasing the value of the quality parameter by a predetermined range, performing the memory test and determining whether the memory test is passed or not; if the memory test is failed, stop to decrease the value, then the last passed value is the lower bound.

19. The method according to claim 17, wherein the step of tuning a quality parameter of the memory module and performing a memory test to obtain an upper bound and a lower bound of the quality parameter comprises:
increasing a value of the quality parameter by a predetermined range and performing the memory test; and
determining whether the memory test is pass or not;
wherein if the memory test is passed, repeating the step of increasing the value of the quality parameter by a predetermined range, performing the memory test and determining whether the memory test is passed or not; if the memory test is failed, stop to increase the value, then the last passed value is the upper bound.
